(19) United States
(12) Patent Application Publication
(10) Pub. No.: US 2026/0295554 A1
(43) Pub. Date: Oct. 1, 2026

(54) BIOREACTOR SYSTEMS

(71) Applicant: ABEC, Inc., Bethlehem, PA (US)

(72) Inventors: Colton Mitchell, Bethlehem, PA (US); Chris Klopp, Bethlehem, PA (US); John Kiehart, Bethlehem, PA (US)

(73) Assignee: ABEC, Inc., Bethlehem, PA (US)

(21) Appl. No.: 19/480,457

(22) PCT Filed: May 3, 2024
(86) PCT No.: PCT/US2024/027664

§ 371 Date: Oct. 31, 2025

Related U.S. Application Data
(60) Provisional application No. 63/464,368, filed on May 5, 2023.

(51) Int. Cl. B01J 19/00; B01D 61/14; B01D 61/16; B01D 61/18; B01F 35/93; B01J 19/18

(52) U.S. Cl. CPC B01J 19/006; B01D 61/145; B01D 61/16; B01D 61/18; B01F 35/93; B01J 19/18; B01D 2313/221; B01D 2315/10; B01J 2219/00076; B01J 2219/00768; B01J 2219/185; B01J 2219/1943; B01J 2219/1946

(57) ABSTRACT

This disclosure generally relates to reaction systems using reactor vessels and disposable reactor container(s), where the reactor vessels including a cone-, tulip- or frustum- (e.g., frustoconical) bottom section and one or more heat transfer baffle(s) within such a section.

### RELATED APPLICATIONS

This application claims priority to U.S. Provisional Application Ser. No. 63/464,368 filed on May 5, 2023, which is hereby incorporated into this disclosure in its entirey.

### FIELD OF THE DISCLOSURE

This disclosure generally relates to reaction systems using reactor vessels and disposable reactor container(s), where the reactor vessels including a cone-, tulip- or frustum- (e.g., frustoconical) bottom section and one or more heat transfer baffle(s) within such a section.

### BACKGROUND OF THE DISCLOSURE

This disclosure provides solutions to problems associated with the use of reactor vessels and disposable components, such as disposable reaction containers. One such problem encountered in using cone- (or tulip- or frustum- (e.g., frustoconical)) bottom reactor vessels is the temperature differences in the cone/frustum are of the reactor veseel. For instance, cone- or tulip-bottom reactor vessels comprising heat transfer baffles extending from the vertical interior of reactor vessel into the cone- (or tulip- or frustum- (e.g., frustoconical)) bottom of the vessel are provided. This disclosure provides solutions to these and other art-recognized, and unrecognized, problems.

### BRIEF DESCRIPTION OF THE DRAWINGS

FIG. 1. Exemplary reactor vessel including vertical section (A), cone- (or tulip- or frustum- (e.g., frustoconical)) bottom section (B), mechanical implements (C), and interior heat transfer baffles indicated by dashed lines (D).

FIG. 2. Exemplary reactor vessel including vertical section (A), cone- (or tulip- or frustum- (e.g., frustoconical)) bottom section (B), mechanical implements (C), and three heat transfer baffles on vessel interior (D).

FIG. 3. Exemplary reactor vessel including vertical section (A), cone- (or tulip- or frustum- (e.g., frustoconical)) bottom section (B), mechanical implements (C), heat transfer baffles of the vertical section of the reactor vessel (D1), and heat transfer baffles of the vertical section of the cone-/tulip-bottom section (D2).

FIG. 4. Exemplary cone- (or tulip- or frustum- (e.g., frustoconical)) bottom section reactor vessel including mechanical implements (C), heat transfer baffles of the vertical section of the cone-, tulip-, or or frustum- (e.g., frustoconical) bottom section (D2), and internal mechanical implements (e.g., impellar) (E). This embodiment shows the top of internal mechanical implement (e.g., the impellar) (E) positioned at a first reactor volume (22.6 L Vw level in this example) and a minimum working reactor volume (in this example, about 50 L Vw).

FIG. 5. Exemplary top view of an exemplary reactor vessel illustrating three heat transfer baffles (D) extending out from the inner surface of the reactor vessel and into the cone/tulip bottom thereof (not explicitly illustrated) and the mechanical implements (C/E) positioned at the center of the cone-/tulip-bottom section.

FIG. 6. Interior of an exemplary reactor vessel including a cone- (or tulip- or frustum- (e.g., frustoconical)) bottom reactor vessel (A/B), and heat transfer baffles thereof (D1 and D2; three in this preferred embodiment).

FIG. 7. Interior of an exemplary reactor vessel including a cone- (or tulip- or frustum- (e.g., frustoconical)) bottom reactor vessel (A/B), mechanical implements (C), and heat transfer baffles thereof (D1 and D2).

FIG. 8. First view of exemplary, preferred heat transfer baffle.

FIG. 9. Exemplary, preferred heat transfer baffle attached to interior of reactor vessel.

FIG. 10. Second (cutaway) view of exemplary, preferred heat transfer baffle.

FIG. 11. Exemplary embodiment of a reactor system including a cone- (or tulip- or frustum- (e.g., frustoconical)) bottom reactor vessel (A/B), feed and recirculation pumps, and the filter and cassette manifold (e.g., TFF) (F).

FIG. 12. First view of an exemplary embodiment of a reactor system including a cone- (or tulip- or frustum- (e.g., frustoconical)) bottom reactor vessel (A/B) and mechanical implements (C), heat transfer baffle extending from the inner surface of the reactor vessel (D), the filter and cassette manifold (e.g., TFF) (F), and other components of the system (e.g., feed and recirculation pumps, piping and other fluid transfer components, and automation equipment).

FIG. 13. Second view of a preferred embodiment of a reactor system including a cone (or tulip- or frustum- (e.g., frustoconical)) bottom reactor vessel (A/B) and mechanical implements (C), heat transfer baffle extending from the inner surface of the reactor vessel (D), the filter and cassette manifold (e.g., TFF) (F), and other components of the system (e.g., feed and recirculation pumps, piping and other fluid transfer components, and automation equipment).

### SUMMARY OF THE DISCLOSURE

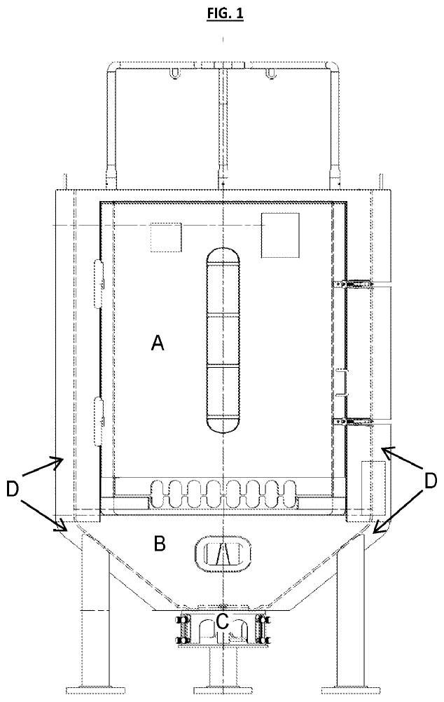

This disclosure relates to a reactor vessel and systems comprising the same, the reactor vessel comprising a vertical section, a cone (or tulip- or frustum- (e.g., frustoconical)) bottom section, one or more heat transfer baffles extending outward from the internal surface of the vertical and cone (or tulip- or frustum- (e.g., frustoconical)) bottom sections of the reactor vessel (see, e.g., the preferred embodiment FIG. 1, section B). In preferred embodiments, the reactor vessel is attached to one or more mechanical implements such as an impellar. In preferred embodiments, the reactor vessel is fluidly connected to at least one filtration system (e.g., a tangential flow filtration (TFF) system). In preferred embodiments, the system further comprises a disposable reaction container contained within the reactor vessel in which a reaction takes place (e.g., reaction components are mixed, cells are grown, etc.) In some embodiments, this disclosure also relates to methods for making and using such systems. In some embodiments, this disclosure also relates to methods for making one or more reaction product(s) (e.g., a mixture, an antibody, a virus preparation, or the like) using these systems. Other embodiments are also contemplated as would be understood from this disclosure by those of ordinary skill in the art.

### DETAILED DESCRIPTION

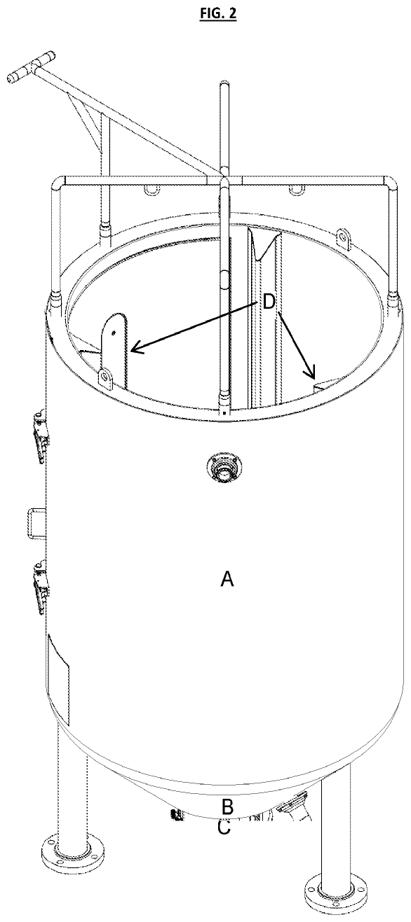

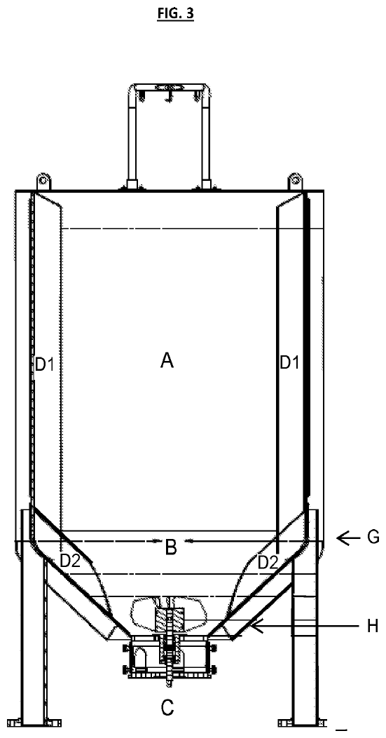

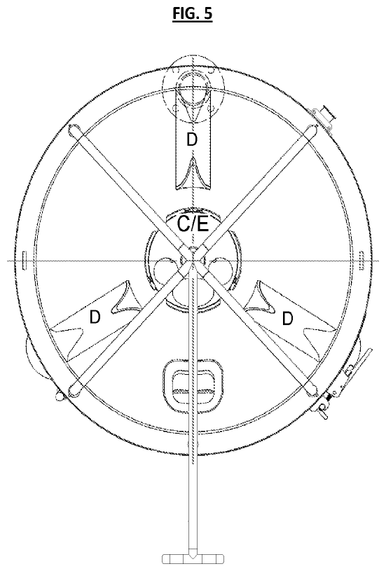

This disclosure generally relates to purification systems using that include a cone- or tulip-bottom reactor vessel and at least one single-use, disposable container (DC) (or “bioprocessing container”; preferably comprised of a flexible leak-proof material such as a plastic (e.g., a film)) contained therein. “Cone-”, “tulip-”, and “frustum-” (e.g., frustoconical)) type reactor vessels are known in the art and can be used interchangeably herein, and refer to the bottom portion of the reactor vessel that angled inward toward the centerpoint of the diameter of the upper vertical walls of the reactor vessel to a nearly pointed bottom (a “cone-type vessel”), curved or flat bottom (e.g., “frustum-” (e.g., frustoconical)) or rounded or double-rounded bottom (tulip-type vessel) (FIG. 1, see e.g., section B thereof). In preferred embodiments, the reactor vesell is a component of a single-use system designed for bioprocess applications requiring excellent fluid mixing across a very large range of volumes, such as ultrafiltration where product is being highly concentrated in solution. The design of the disposable container and the reactor vessel (e.g., “DC holder”) is such that the liquid volume required to operate and achieve high quality mixing is greatly reduced. The geometry of the system preferably provides for about a 25:1 turndown to allow, e.g., a 1000 L working volume system to be operated with both mixing and sensing at 40 L. The cone, tulip or frustum (e.g., frustoconical)) shape of the lower portion of the reactor vessel (e.g., “bottom head”) allows for a combination of multiple single-use or conventional probes such as temperature, dissolved oxygen, pCO₂, and gel-based pH, and also allows the use of various tube sets for additions, recirculation, or fluid transfer. Attached to the interior surface of the reactor vessel are multiple (e.g., two, three, four or more) baffles (the number being about proportional to reactor vessel diameter) which are used to break up, interfere, and/or otherwise affect the flow path or the reaction components being reacted and/or mixed within the disposable container to prevent vortex formation therein. Such baffles preferably extend along the entire height of the reactor vessel, including the vertical walls and cone- (or tulip- or (or tulip- or frustum- (e.g., frustoconical)) bottom sections (e.g., section B in FIG. 1), terminating at the working volume and at the base of the bottom head (FIGS. 2, 5, 7, and 8, component D (baffles); FIG. 3, components D1 and D2 (baffles)). The baffles are designed in such a way that a single-use DC can easily conform to the baffles while minimizing the wrinkling of the DC/film. In preferred embodiments, the system includes a bottom-mounted direct-drive technology that couples the single-use DC to the agitator drive assembly (FIGS. 1-4, components C, E).

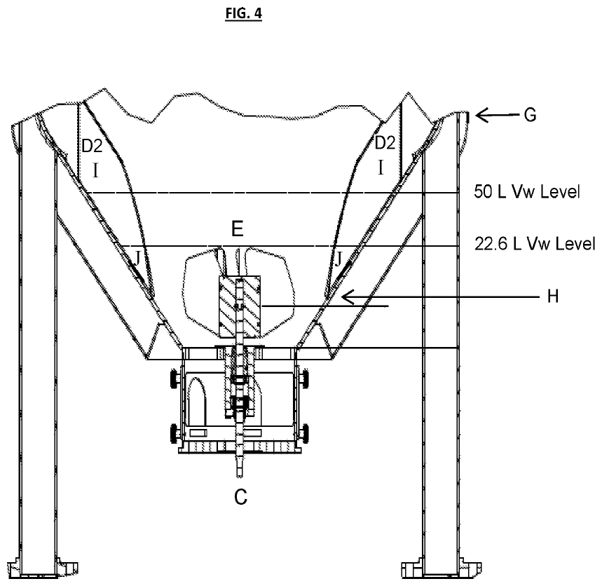

Cone-, tulip-, or frustum- (e.g., frustoconical) bottom reactor vessels typically used in the bioreactor and fermentor fields typically include a heat transfer baffle of a does not extend into the cone/tulip bottom portion of the vessel but instead terminate on the vertical portion (e.g., A of FIGS. 1-3) of the reactor vessel wall prior to the cone/tulip bottom (B of FIGS. 1-3). As mentioned herein, this arrangement results in temperature differences between the reaction components within the portion of the DC positioned in the main (e.g., vertical) body of the reactor vessel as compared to the reaction components within the portion of the DC positioned in the cone-, tulip-, or frustum- (e.g., frustoconical) bottom section of the reactor vessel. The reactor vessels disclosed herein include one or more heat transfer baffle(s) of the cone, tulip, frustum (e.g., frustoconical) section of the reactor vessel (e.g., component D2 of FIGS. 3-4, 6-7) that extend from the interior surface reactor vessel interior surface toward the center area point of the reactor vessel (e.g., the cone, tulip, or frustum (e.g., frustoconical) section). In preferred embodiments, heat transfer baffle(s) D2 extends out from the interior surface of the reactor vessel to an appropriate length (e.g., in preferred embodiments approximately one tenth the diameter of the vertical section of reactor vessel). In preferred embodiments, heat transfer baffle(s) D2 are wider at the point at which the cone or tulip or frustum (e.g., frustoconical) section begins (point G in FIGS. 3-4) and taper towards the bottom of the cone, tulip or frustum (e.g., frustoconical) section (point H in FIGS. 3-4). Thus, the top portion of the heat transfer baffle(s) D2 (I in FIG. 4) is wider than the bottom portion (J in FIG. 4) (i.e., the diameter of the heat transfer baffle in the cone, tulip or frustum (e.g., frustoconical) shaped upper section is greater at point I is greater than J (e.g., tapered toward the bottom), and gradually decreases from point I to J, preferably in approximately a proportionally shaped triangle). In especially preferred embodiments, the heat transfer baffle(s) in the cone, tulip or frustum (e.g., frustoconical) section of the reactor vessel is in fluid communication with the heat transfer baffle (i.e., the heat transfer baffle(s) of the vertical and cone/tulip sections of the reactor vessel is/are a single construct). In other preferred embodiments, the heat transfer baffle(s) in the cone, tulip, frustum (e.g., frustoconical) section of the reactor vessel is not in fluid communication with the heat transfer baffle (i.e., the heat transfer baffle(s) of the vertical and cone/tulip sections of the reactor vessel are not a single construct but instead provide two different heat transfer systems) such that the temperature of the heat transfer fluid traversing the heat transfer baffle(s) of the vertical section of the reactor vessel is/are/can be of a first temperature and the temperature of the heat transfer fluid traversing the heat transfer baffle(s) of the vertical section of the reactor vessel is/are of a second temperature, higher or lower than the first, such that the temperature of the reaction components/mixture present in the vertical and cone, tulip, or frustum (e.g., frustoconical) bottom sections of the reactor vessel can be separately maintained. A combination of different types of heat baffles can also be used such that one or more heat transfer baffle that extends into the cone, tulip, or frustum (e.g., frustoconical) bottom sections, and at least one heat transfer baffle that does not. In some embodiments, the second temperature may be lower than the first temperature because the mixture present in the cone, tulip or frustum (e.g., frustoconical) section is of a higher temperature than that in the vertical section and adjustment of the temperature of the heat transfer fluid traversing through the heat transfer baffles in the vertical and cone, tulip or frustum (e.g., frustoconical) sections by the heat transfer fluid flowing through the heat transfer baffle(s) to provide a consistent temperature of the reaction components/mixture in both sections of the reactor vessel. In some embodiments, heat transfer fluids of different temperatures can be circulated through different sections of the heat transfer system in order to maintain the reaction components at different temperatures in different sections (e.g., vertical section as compared to the cone, tulip or frustum (e.g., frustoconical) section). Other arragments may also be used as would be understood by those of ordinary skill in the art.

In some embodiments, the reactor vessel can take the form of a standard bioreactor or fermentation vessel as these are understood by those of ordinary skill in the art. In some embodiments, the reactor vessel can be insulated, jacketed and/or include one or more heat transfer systems. The term “vessel” refers to a tank, container, and/or reservoir that can hold or maintain fluid, and/or in some embodiments provide a source for feed and/or retentate. In some embodiments, the reactor vessel can have a form and/or used in a system disclosed in, for instance and without limitation, U.S. Pat. No. 8,658,419 (ABEC, Inc.), U.S. Pat. No. 9,228,165 B2 (ABEC, Inc.), U.S. Pat. No. 10,519,415 B2, WO 2019/070648A2, WO 2022/109371 A2 (ABEC, Inc.). In some embodiments, the disposable reactor vessel can be a cone-bottom, tulip-bottom, or frustum (e.g., frustoconical)-bottom vessel and/or preferably has a capacity of at least 20 L. Other types of suitable feed vessels that could be used as disclosed herein are also known in the art as would be understood by those of ordinary skill in the art. The materials used to produce the equipment described herein may be of the same or different composition. The reactor vessels and/or heat exchange components described herein are typically but not necessarily constructed from a corrosion-resistant alloy (e.g., metal). For instance, suitable materials may include, without limitation, dimple-jacket material and/or sheet/plate stock. Suitable materials include, for example, carbon steel, stainless steel (e.g., 304, 304L, 316, 316L, 317, 317L, AL6XN), aluminum, Inconel® (e.g., Inconel 625, Chronin 625, Altemp 625, Haynes 625, Nickelvac 625 and Nicrofer 6020), Incoloy®, Hastelloy (e.g., A, B, B2, B3, B142T, Hybrid-BC1, C, C4, C22, C22HS, C2000, C263, C276, D, G, G2, G3, G30, G50, H9M, N, R235, S, W, X), and Monel®, titanium, Carpenter 20®, among others. It is understood, however, that other materials besides or in addition to a corrosion-resistant alloy such as, but without limitation, plastic, rubber, and mixtures of such materials may also be suitable. A “mixture” of materials may refer to either an actual mixture per se to form a combined material or the use of various materials within the system (e.g., an alloy reactor shell and rubber baffle components). Regarding the channeled material referred to above, any of the suitable materials described above may be prepared such that channels are formed through which heat transfer media may be distributed.

The reaction vessel comprises an internal chamber, and in preferred embodiments is associated with and/or includes at least heat transfer system comprising a heat transfer apparatus for controlling the temperature of a chemical, pharmaceutical or biological process being carried out in within an internal reaction chamber of the vessel. In some embodiments, the heat transfer system provides for distribution of a heat transfer medium such that heat resulting from or required by the process is transferred from or to the reaction mixture. In some embodiments, the reaction vessel comprises a jacket and/or a jacketed tank head that provides a fluidic channel through which a heat transfer fluid may be circulated (e.g., a dimple jacket). In some embodiments, the reaction vessel may be a least partially surrounded by a fluidic channel. The jacketed tank head may also act as a lid for the reaction vessel. The jacketed tank head may also serve to support and/or relieve pressure on a DC (e.g., on the top of the DC) contained within the reactor vessel.

In some embodiments, the one or more heat exchange systems may comprise jacket through which a heat transfer fluid is circulated. The jacket may, for instance, comprises channels through which the heat transfer fluid is circulated. In some embodiments, the jacket may be a “dimpled” material. Dimple jackets are typically installed around reaction vessels such as fermentation tanks and may be used as part of a heat transfer system. Dimple jacket material may be used in the devices described herein in the typical fashion, e.g., wrapped around the reaction vessel. In certain embodiments described herein, dimple jacket material may be also or alternatively used within the baffle structure. Dimple jacket materials are commercially available, and any of such materials may be suitable for use as disclosed here. Typically, dimple jacket materials have a substantially uniform pattern of dimples (e.g., depressions, indentations) pressed or formed into a parent material (e.g., a sheet of metal). Dimple jacket materials may be made mechanically (“mechanical dimple jacket”) or by inflation (e.g., inflated resistance spot welding (RSW)), for example. To prepare a mechanical dimple material, a sheet of metal having a substantially uniform array of dimples pressed into, where each dimple typically contains a center hole, is welded to the parent metal through the center hole. An inflated RSW dimple material (e.g., inflated HTS or H.T.S.) is typically made by resistance spot welding an array of spots on a thin sheet of metal to a more substantial (e.g., thicker) base material (e.g., metal). The edges of the combined material are sealed by welding and the interior is inflated under high pressure until the thin material forms a pattern of dimples. Mechanical dimple materials, when used as jackets, typically have high pressure ratings and low to moderate pressure drop, while RSW dimple jackets typically exhibit moderate pressure ratings and a high to moderate pressure drop. Heat transfer fluid typically flows between the sheets of dimpled material. Other suitable dimple materials are available to those of skill in the art and would be suitable for use as described herein.

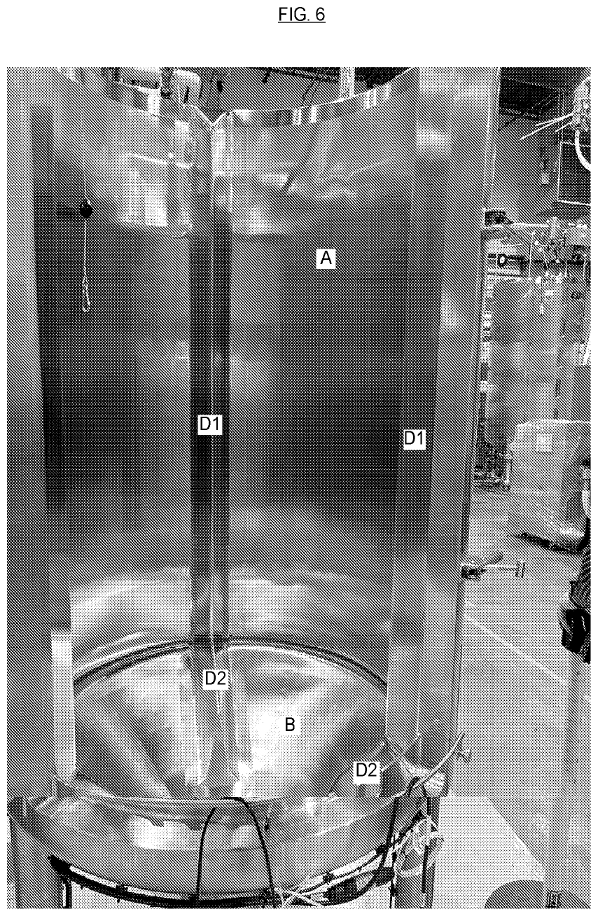

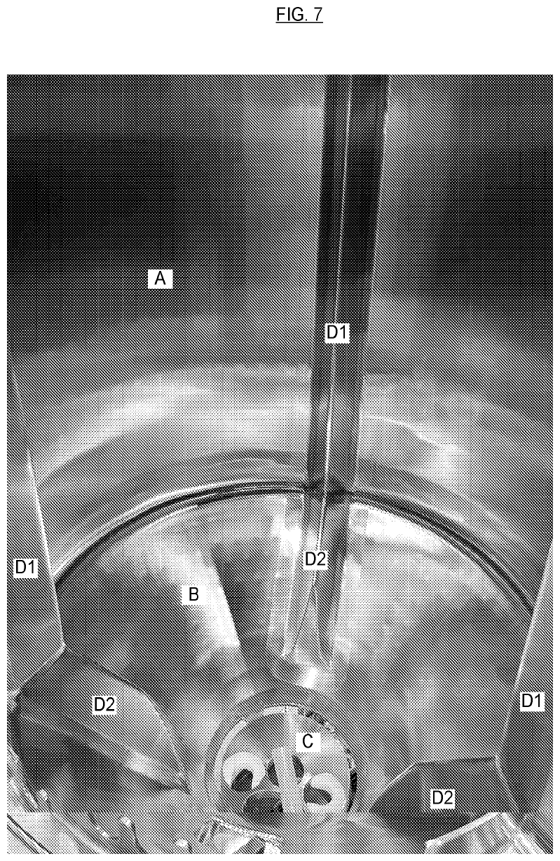

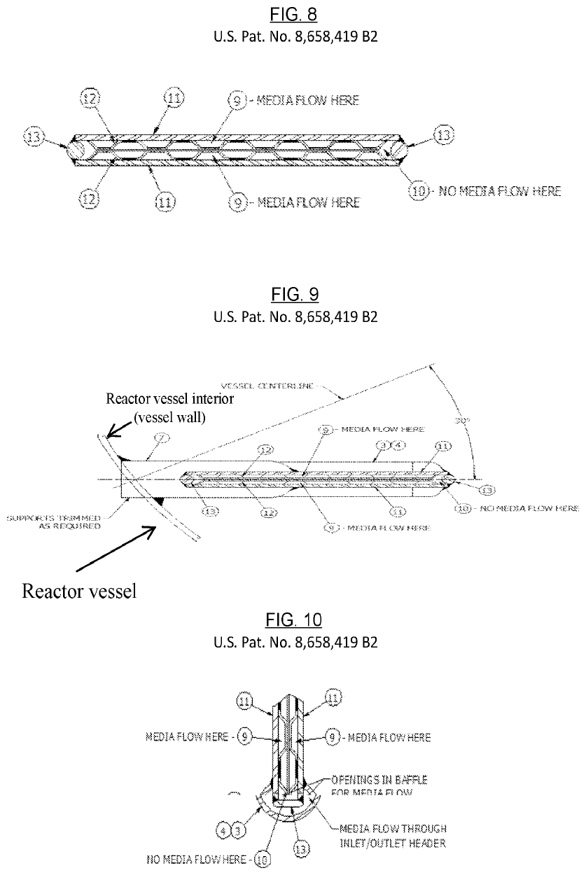

In preferred embodiments, the reactor vessels disclosed herein comprise one or more heat transfer systems that efficiently transfer heat, withstand the hydraulic forces encountered within a reaction vessel, and may be simply and efficiently sanitized. A suitable heat transfer baffle described herein may be incorporated into heat transfer systems to solve these problems. Preferred exemplary heat transfer baffles are disclosed and/or claimed in U.S. Pat. No. 8,658,419 B2, which is incorporated herein in its entirety, such as that disclosed herein is illustrated in FIGS. 8-10. In certain embodiments, the baffle has at least one internal channel (e.g., 9 in FIGS. 8-10) and at least two external channels (e.g., 10 in FIGS. 8-10). Typically, heat transfer media is circulated through one or more distribution channels (e.g., 9 in FIGS. 8-10) but not the one or more relief channels (e.g., 10 in FIGS. 8-10), which may also function as a vent(s) for the distribution channels. Distribution channels 9 are typically formed between the support material 11 and dimple jacket material 12 of each sub-assembly. Relief channel(s) 10 are typically formed by adjoining two sub-assemblies, each comprising support material 11 fixably attached to dimple jacket material 12 to one another. In such embodiments, the dimple jacket material and support material of each sub-assembly are typically adjoined to one another by welding or other process resulting in the materials being fixably attached to one another. The sub-assemblies are typically adjoined to one another using closure bars 13. The closure bar is typically adjoined to the support material by a welding or other process that results in a substantially seamless joint. The width of the closure bar may be adjusted to set the width of the relief channel as desired (e.g., setting the juxtaposed dimple jacket material closer together or further apart). One or more relief holes may be made within the closure bars such that relief channel(s) may communicate with the reaction vessel exterior. The incorporation of distribution and relief channels into the baffle provides exceptional heat transfer capabilities and the structural integrity necessary to withstand the hydraulic forces encountered in a reaction vessel. The baffles may protrude at regular or irregular intervals from the inner wall of the reaction vessel. The baffles may also be installed at any suitable angle relative to the inner wall of the reaction vessel (e.g., 60° relative to the interior wall, 30° relative to the radius of the reactor vessel). A suitable angle may be an angle that would be understood by the skilled artisan to be appropriate in order to or sufficient to attenuate the forces (e.g., hydraulic forces) encountered by the baffles resulting from motion (e.g., rotational and/or swirl motion) of the vessel contents resulting from the agitation (e.g., mechanical or otherwise) thereof. A suitable angle is one that would prevent damage to the baffles from the forces resulting from such motion. Suitable angles include, for example, 5°, 10°, 15°, 20°, 25°, 30°, 35°, 40°, 45°, 50°, 55°, 60°, 65°, 70°, 75°, 80°, 85°, or 90° relative to either the interior wall of the vessel or the radius of the vessel. Where the reaction vessel contains a mechanism (e.g., mechanical or other mechanism) for agitating or mixing a reaction, such as a set of rotating blades or the like (e.g., an axial flow or radial flow impeller), the baffles are affixed to or protrude from the inner wall such that the mechanism and the baffles are not in contact with one another. For instance, where a device or devices for mixing the reaction components is located at the bottom center of the vessel, the baffles may be installed above the highest point of said means. Where multiple mechanical mechanisms are utilized, the baffles are typically configured to avoid those mechanisms. For instance, where the mechanism includes one or more sets of rotating blades, the baffle(s) may be positioned above, below, between or alongside the blades. The baffle design will ensure adequate clearance from the mechanical mechanisms. The baffle assembly is typically fixably attached to the vessel through attachment arm or arms 7 by a welding or other process that results in a substantially seamless joint. As described above, use of the attachment arms advantageously provides for efficient cleaning and/or sanitization of the baffles in that very little to no residue remains at the joint between the interior surface of the reaction vessel and the baffle following the attachment process (e.g., welding). Similarly, the baffle may be incorporated into, attached or affixed to a reaction vessel by any suitable method provided that method provides a substantially seamless attachment point (e.g., a seamless joint or boundary between materials) to provide a surface that may be simply and efficiently sanitized (see, e.g., the edge between baffle D2 and cone/tulip bottom section B of FIG. 7). A “substantially seamless attachment point”, “seamless joint”, or “crevice-free joint” typically indicates that the boundary between the baffle and the reaction vessel is substantially undetectable by either visual and/or other means (e.g., microscopy). It may also indicate that the boundary does not retain any residue from prior reactions following a standard cleaning procedure typically used by the skilled artisan to “sanitize” such equipment. The system is therefore suitable for sanitization using industry-accepted “clean-in-place” and “sterilize-in-place” systems using any suitable cleaning agent including but not limited to detergents, brushes, and/or steam. Such a boundary affords itself to simple and efficient sanitization.

Suitable heat transfer media include and are not limited to fluids and gases. Suitable fluids and gases include and are not limited to steam (top to bottom), hot and cold water, glycol, heat transfer oils, refrigerants, or other pumpable fluid having a desired operational temperature range. It is also possible to use multiple types of heat transfer media such that, for instance, one type of media is directed to one area of the reaction vessel and another type of media is directed to a different area of the reaction vessel (e.g., as in the zonal system described above). Mixtures of heat transfer media (e.g., 30% glycol) may also be desirable

The reactor vessels of this disclosure, in preferred embodiments, are used with a disposable container that is positioned within the vessel. A disposable container is preferebly one made of disposable (e.g., single use), re-usable (e.g., sterilizable), and/or replaceable / swappable material, the same being commercially available to those of ordinary skill in the art. In preferred embodiments, the components of the systems disclosed herein are single use disposable materials. Exemplary, non-limiting components that can be included in the TFF systems can include Flexware® components (Mobius®), FlexReady Solution components (EMD Millipore Corporation), and/or Allegro™ components (Pall Corporation, Port Washington, N.Y.) In some embodiments, disposable feed and/or retentate conduits can be made from disposable tubing. In some embodiments, disposable components can be and/or can be used with other disposable components such as T line, valve (e.g., feed and/or retentate, or permeate vessel and/or conduit valve, such as a pinch or diaphragm valve). Typically such components are compatible with other components of the system, are non-toxic, high-strength, sanitary, and/or re-usable. In some embodiments, the system can also comprise one or more pressure sensor(s) (e.g., comprising a diaphragm) which may also be disposable and/or re-usable. In preferred embodiments, the components of the system, individually and/or as one or more units thereof, can be sanitized (e.g., sterilized) prior to use, which can be carried out using standard techniques including but not limited to gamma radiation, ethylene oxide (ETO), bleach (e.g., Clorox), chlorine (e.g., NaOCl), peroxide, acid (e.g., peracetic acid), base (e.g., NaOH), formaldehyde (e.g., formaline solution) or heat, or an appropriate combination thereof.

In some embodiments, the system comprises a single use disposable container (DC) comprising a film forming (e.g., surrounding) a headspace (“HS”) in the DC which is maintained at a temperature lower than the portion of the DC in which a reaction is carried out (e.g., fluid reactants); and/or, a condenser directly associated with/in contact with the film forming the headspace; and/or a coalescing device enhancing liquid gathering (e.g., collection) and drainage from the headspace. In some embodiments, the DC system may comprise a DC comprising first and second zones; the first zone comprising a reaction mixture maintained at a first temperature; the second zone comprising a HS maintained at a second temperature lower than that of the first temperature, the HS comprising an upper interior surface (adjacent to or opposite an exterior surface) and at least one sidewall; and, a coalescer for collecting fluid condensed in and escaping from the upper interior surface and/or at least one sidewall of the HS. In some embodiments, a heat exchange device contacts the HS and/or is provided within the HS. In some preferred embodiments, the temperature difference may be about 5-10 °C (i.e., the first temperature can be 5-10 °C warmer than the second temperature or, in other words, the second temperature can be 5-10 °C cooler than the first temperature). In some embodiments, such a heat exchange device contacts the sidewall(s) and/or upper interior and/or exterior surface of the HS. In most and preferred embodiments, the DC is surrounded by a reaction vessel, which typically provides support to the DC and other components of the system. In some such embodiments, this type of system is similar to or the same as that disclosed in WO 2019/070648 A2 (see, e.g., U.S. Pat. No. 11,623,200 B2).

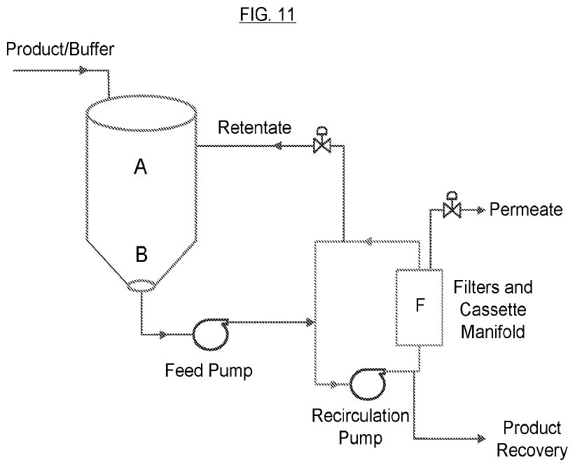

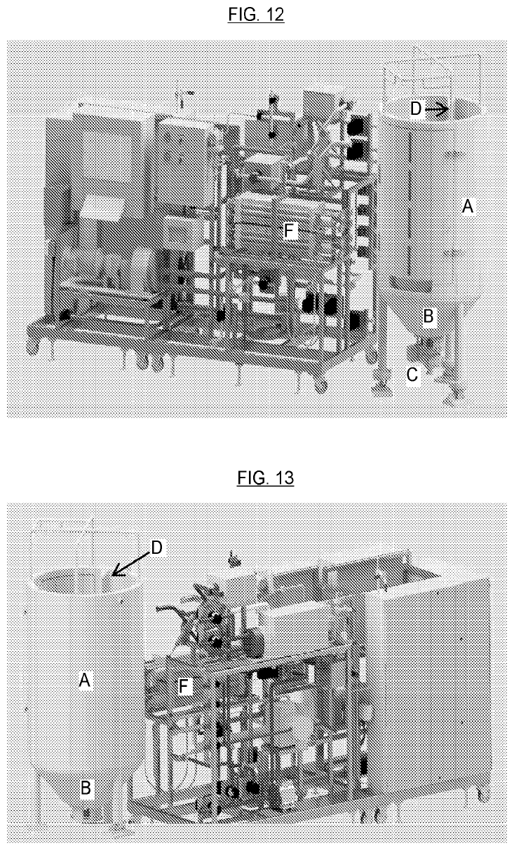

In some embodiments, the system can include one or more disposable feed vessels that can be a container in which a solution such as feed material and/or retentant can be maintained, separated from other components of a system, and/or serve a source of material for processing through a filter, such as but not limited to a tangential flow filter (“TFF”). In some embodiments, such a system including a TFF (i.e., “TFF system”) can be that described in, e.g., WO 2022/109371 A1 (PCT/US2021/060264 filed Nov. 22, 2021). For instance, such TFF systems can also include one or more conduits (e.g., tubing, piping) for feed, retentate and permeate, a housing or enclosure, valves, gaskets, a pump module (e.g., pump module comprising a pump housing, diaphragm and check valve) one or more vessles (e.g., reservoirs containers), and/or one or more pressure gauges. In some embodiments, the TFF systems can comprise at least one feed vessel, and at least one disposable retentate vessel, where at least one feed vessel and at least one disposable retentate vessel can be the same, one or more disposable permeate vessels, an optional disposable buffer vessel with one or more pumps and pump drives controlling the flow of feed material, retentate and/or permeate, at least one TFF filter coupled with a disposable cassette manifold (and in preferred embodiments multiple TFF filters), wherein such components are fluidly connected to one another such that feed and/or other materials can flow from and/or through one or more of the same, the system optionally comprising one or more valves that directs the flow of feed material, retentate and/or permeate to the various components of the system. In some embodiments, this disclosure provides tangential flow filtration (TFF) systems comprising a disposable TFF flow path comprising of a disposable cassette manifold, a first fluid pathway comprising low-pressure disposable tubing, a second fluid pathway comprising high-pressure disposable tubing, and a disposable reactor vessel (see, e.g., FIGS. 11-13). In some embodiments, the TFF system further comprises at least one a recirculation pump, wherein: the disposable reactor vessel is fluidly connected to the disposable low-pressure tubing and the recirculation pump; the recirculation pump is fluidly connected to a section of disposable high-pressure tubing (e.g., Kynar tubing) that supplies feed material the disposable cassette manifold (high-pressure supply loop), the recirculation pump is fluidly connected to a section of disposable high-pressure tubing that returns feed material from the disposable cassette manifold to the recirculation pump (high-pressure return loop); and, the disposable reactor vessel is not directly fluidly connected to the high-pressure disposable tubing. In preferred embodiments, the disposable cassette manifold comprises at least one feed material inlet conduit, at least one permeate discharge conduit, and at least one retentate outlet conduit, further preferably wherein each of the at least one feed material inlet conduit, at least one permeate discharge conduit, and at least one retentate outlet conduit are each fluidly connected to disposable high-pressure tubing. In preferred embodiments, the disposable cassette manifold can stably process feed material at a pressure of up to about 60 pounds per square inch (gauge) (psig) (e.g., Kynar tubing). In preferred embodiments, the disposable cassette manifold is comprised of plastic, optionally wherein the plastic comprises or consists of nylon or high-density polythylene (HDPE). In preferred embodiments, the disposable high-pressure tubing has a Shore durometer of at least about 40 D, optionally at least about 50 D, and preferably about 60 D, as determined under the ASTM D2240 standard, a standard recognized by those of ordinary skill in the art. In other embodiments, the disposable high-pressure tubing can be braided tubing that can process the required pressure and flow rate. In preferred embodiments, the disposable cassette manifold is fluidly connected to one or more TFF filtration cassette(s) (as a filtration unit) that each (or in combination) provide approximately 5 m² to in excess of 40 m² surface area for filtration of feed material. In some embodiments, the TFF system can include multiple TFF cassettes fluidly connected in series, wherein feed material and optionally retentate flows from an initial TFF cassette to a terminal TFF cassette, optionally wherein at least one additional TFF cassette is positioned between the initial TFF cassette and the terminal TFF cassette. In some embodiments, the disposable reactor vessel is a cone-bottom or tulip-bottom vessel. In some embodiments, the disposable reactor vessel comprises the feed material and/or retentate. In some embodiments, the TFF system includes at least one valve for controlling flow into and/or from one or more of said filtration elements, said at least one valve being fluidly connected to at least one pump, optionally wherein at least one valve and/or at least one pump are controlled by a computer.

Other embodiments are also disclosed and/or contemplated and/or can be contemplated from this disclosure by those of ordinary skill in the art. Various embodiments of the present disclosure will be described in detail with reference to drawings, if any. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The following terms are used herein, unless otherwise described. “Fluidly connected” means that one system component (e.g., disposable cassette manifold) is connected to another, and/or a different type of component, by at least one liquid conduit that provides for the flow of liquid between the system components (e.g., a feed material conduit or channel, a retentate conduit or channel, a permeate conduit or channel). Fluidly connected parts or components, or parts or components sharing a “fluidic connection”, are parts or components of the system connected by a conduit or channel through which fluid (e.g., feed material, retentate, permeate) traverses the system. A “direct” fluidic connection is one by which system components are fluidly connected to on another such that the fluid does not flow through any intervening system components (e.g., a system component positioned between two other system components). In some embodiments, for instance, the reactor vessel and/or disposable container therein is directly fluidly connected to low-pressure conduit but not high-pressure conduit or the recirculation pump, while the feed pump can be directly connected to both low-pressure conduit (e.g., from the feed vessel) and directly connected to high-pressure conduit (e.g., to and from the high pressure tubing). A “product” is a compound such as a protein (e.g., an antibody) that is present in a liquid that is being concentrated and/or isolated using the system. “Parallel” refers to a process in which a plurality of components (e.g., filtration units) are fluidly connected such that liquid is distributed from an inlet directly to each of the components of the system. “Serial” refers to a process in which a plurality of system componetns are fluidly connected such that the fluid is distributed only to an initial component in the system and subsequent components in the system receives their respective fluid from a preceding component. “Tangential flow filtration,” (TFF) refers to filtration in which a product-containing solution (e.g., feed material) passes tangentially across a TFF filter membrane and lower molecular weight salts or solutes are passed through by applying pressure. “Feed material” refers to the solution being delivered to the TFF system for filtration and/or separation. “Separation” refers separating the feed material into at least two streams, typically permeate and retentate. “Permeate” refers to the portion of the feed material that has permeated through the membrane of the TFF filter. “Retentate” is the portion of the solution being filtered that has been retained by the TFF filter (i.e., membrane thereof), and the retentate is the fluid enriched for at least one protein that was present in the feed material. “Fluidly connecting” or “fluidly connected” is used indicates that the parts/components being connected to each other provide for the flow of fluid between such parts/components. “Flow path” refers to a channel (single pass or recirculation path) comprising a TFF membrane (e.g., ultrafiltration, microfiltration) through which a solution flows in TFF mode (e.g., and can be of any appropriate type including but not limited to straight, coiled, and/or serpentine, open, including obstructions, with or without spacers). A “filtration unit” is a disposable cassette manifold coupled with one or more TFF filters and/or TFF filtration cassettes. A “disposable cassette manifold” is a device supporting and coupled with one or more TFF filters and/or, preferably, TFF cassettes. A “TFF cassette” is a cartridge or structure comprising at least one TFF filtration membrane (e.g., ultrafiltration, microfiltration). “Filtration membrane” is a permeable membrane for separating feed material into permeate and retentate (by, e.g., ultrafiltration, microfiltration, reverse osmosis, and/or nanofiltration. “Ultrafiltering”, “microfiltering”, and like terms refer to, for example, using synthetic semi-permeable membranes, with appropriate physical and chemical properties, to discriminate between molecules in the mixture, primarily on the basis of molecular size and shape, and accomplish separation of different molecules or accomplish concentration of like molecules. In some embodiments, an “ultrafiltration membrane” is a membrane having pore sizes in the range of between about 1 nanometer to about 100 nanometers. In some embodiments, a “microfiltration membrane” is a membrane having a pore sizes in the range between about 0.1 micrometers to about 10 micrometers (including all values in between). “Diafiltering,” “diafiltration,” “diafiltered,” “diafiltrating,” “DF,” and like terms refer to, for example, using an ultrafiltration membrane to remove, replace, or lower the concentration of salts or solvents from solutions or mixtures containing proteins, peptides, nucleic acids, or other biomolecules.

This disclosure includes but is not limited to the following aspects: 1) a reactor vessel comprising a vertical section and a cone or tulip shaped section and at least one heat exchange system comprising at least one heat exchange baffle within the cone, tulip or frustum (e.g., frustoconical) section shaped section; 2) the reactor vessel of aspect 1 wherein the heat exchange baffle is fluidly connected between the vertical section and cone, tulip, or frustum (e.g., frustoconical) shaped sections of the reactor vessel; 3) the reactor vessel of aspect 1 wherein the heat exchange baffle is not fluidly connected between the vertical section and cone or tulip shaped sections of the reactor vessel, such that the vessel comprises at least two heat exchange baffles; 4) the reactor vessel of claim 3 wherein one of the at least two heat exchange baffles is positioned within the vertical section of the reactor vessel and one of the at least two heat exchange baffles is positioned within the frustoconical) section of the reactor vessel; 5) the reactor vessel of claim 4 wherein the at least two heat exchange baffles can comprise heat exchange fluid having a temperature that is the same or different; 6) the reactor system comprising a reactor vessel of any one of aspects 1-5; 7) the reactor system of claim 6 further comprising at least one tangential flow filtration (TFF) system; 8) the method for purifying and/or concentrating a product using a reactor vessel or reactor system of any prior claim; 9) the product prepared by a method of claim 8; and, 10) method for preparing a reactor vessel or reactor system of any previous claim comprising preparing a reactor vessel comprising a vertical section and a frustoconical) shaped section and positioning at least one heat exchange system comprising at least one heat exchange baffle within the cone or tulip shaped section. Other embodiments are also contemplated herein as will be understood by those of ordinary skill in the art.

The terms “a”, “an”, and/or “the” typically means at least one, or one or more. The terms “about”, “approximately”, and the like, when used as a modifier refers to a variant of a number that typically occurs in carrying out standard procedures. In some preferred embodiments, “about”, “approximately”, and the like, indicates a numerical value of within ten percent (i.e., +/−10%) of the listed numerical value. The terms “about”, “approximately”, and the like, when preceding a list of numerical values or range, refer to each individual value in the list or range independently as if each individual value in the list or range was immediately preceded by that term. Optional or optionally means that the subsequently described event or circumstance can or cannot occur, and that the description includes instances where the event or circumstance occurs and instances where it does not. Ranges may be expressed herein as from about one particular value, and/or to about another particular value. When such a range is expressed, another aspect includes from the one particular value and/or to the other particular value. Similarly, when values are expressed as approximations, by use of the antecedent about or approximately, it will be understood that the particular value forms another aspect. It will be further understood that the endpoints of each of the ranges are significant both in relation to the other endpoint, and independently of the other endpoint. Ranges (e.g., 90-100%) are meant to include the range per se as well as each independent value within the range as if each value was individually listed.

All references cited within this disclosure are hereby incorporated by reference in their entirety. Certain embodiments are further described in the following examples. These embodiments are provided as examples only and are not intended to limit the scope of the claims in any way.

Other advantages of the reagents and methods of using the same are also provided herein, as would be understood by those of ordinary skill in the art. While certain embodiments have been described in terms of the preferred embodiments, it is understood that variations and modifications will occur to those skilled in the art. Therefore, it is intended that the appended claims cover all such equivalent variations that come within the scope of the following claims.

What is claimed is:

1. A reactor vessel comprising a vertical section and a cone-, tulip-, or frustum-shaped section and at least one heat exchange system comprising at least one heat exchange baffle within the cone tulip or frustum section.

2. The reactor vessel of claim 1 wherein the heat exchange baffle is fluidly connected between the vertical section and cone-, tulip-, or frustum-shaped sections of the reactor vessel.

3. The reactor vessel of claim 1 wherein the heat exchange baffle is not fluidly connected between the vertical section and cone-, tulip-, or frustum-shaped sections of the reactor vessel, such that the vessel comprises at least two heat exchange baffles.

4. The reactor vessel of claim 3 wherein one of the at least two heat exchange baffles is positioned within the vertical section of the reactor vessel and one of the at least two heat exchange baffles is positioned within the cone or tulip section of the reactor vessel.

5. The reactor vessel of claim 4 wherein the at least two heat exchange baffles can comprise heat exchange fluid having a temperature that is the same or different.

6. A reactor system comprising a reactor vessel of any one of claims 1-5.

7. A reactor system of claim 6 further comprising at least one tangential flow filtration (TFF) system.

8. A method for purifying and/or concentrating a product using a reactor vessel or reactor system of any prior claim.

9. A product prepared by a method of claim 8.

10. A method for preparing a reactor vessel or reactor system of any previous claim comprising preparing a reactor vessel comprising a vertical section and a cone-, tulip-, or frustum-shaped section and positioning at least one heat exchange system comprising at least one heat exchange baffle within the cone or tulip shaped section.
